(19) United States
(12) Patent Application Publication
(10) Pub. No.: US 2025/0162044 A1
(43) Pub. Date: May 22, 2025

(54) ROTARY TOOL GUIDE

(71) Applicant: Airbus Operations Limited, Bristol (GB)

(72) Inventor: Phillip HUGHES, Bristol (GB)

(21) Appl. No.: 18/952,596

(22) Filed: Nov. 19, 2024

(30) Foreign Application Priority Data
Nov. 22, 2023 (GB) 2317838.7

(51) Int. Cl. B23B 47/28; B64F 5/10

(52) U.S. Cl. CPC B23B 47/287; B64F 5/10

(57) ABSTRACT

The disclosure relates to a rotary tool guide having a top side, an underside and a set of rigid guide members, a set of guide holes each of which extends through one of the guide members. The guide holes are arranged to guide a rotary tool such as a drill or countersink therethrough. The guide members are spaced apart by flexible portions which can deform so as to allow the underside to change shape to conform to a surface of a workpiece.

### CROSS RELATED APPLICATION

This application claims priority to United Kingdom Patent Application GB 2317838.7, filed Nov. 22, 2023, the entire contents of which is hereby incorporated by reference.

### BACKGROUND OF THE INVENTION

The present disclosure relates to the field of guiding rotary tools such as drills and countersinks. It relates particularly, but not exclusively, to a rotary tool guide, an orientation structure for a rotary tool, a method of machining a workpiece, a workpiece and an aircraft.

In fields such as aircraft manufacturing, it is often desired to drill a set of holes in a workpiece with high precision, that is to say that the holes run at the required angles, and at the required locations (relative to one another and/or relative to features of the workpiece). As an example, aircraft wings often have one or more manholes to allow a person to climb part way into the wing for the purposes of inspection and maintenance. Such manholes are generally elliptical in shape, with an array of holes around their perimeter which are used to attach a manhole cover.

In the case of aircraft manholes and similar structures it can particularly difficult to drill holes freehand with the necessary levels of precision. Accordingly, drilling jigs are often used. These are rigid structures which are attachable to workpieces (for instance wing skins in which manholes have been formed or will be formed) and which have guide holes through which a drill can be inserted before drilling the workpiece. The guide holes determine the angles and locations of the holes, therefore if the jig is positioned correctly on the workpiece then high precision can be achieved.

One problem with this approach is that workpieces may differ from one another due to manufacturing variation. For instance in the case of wing manholes the skins of two supposedly identical wings may have slightly different shapes. Conventional jigs are designed to fit to one specific workpiece geometry, therefore variations in workpiece geometry may lead to a jig failing to seat correctly. This, in turn, can mean that holes produced using the jig are out of tolerance in terms of angle and/or position.

Another problem with existing jigs is that being designed to fit with one specific workpiece geometry, workpieces of even slightly different geometry may require separate jigs. For example aircraft wings often have several manholes distributed along their length, and due to the geometry of the wing changing slightly along its span each manhole normally requires a separate jig tailored to that specific geometry. This makes the manufacturing process more lengthy and thus expensive, as well as meaning tooling costs are relatively high.

Another approach is to use a flexible template, for instance a polycarbonate sheet in which guide holes are provided. Being flexible, such templates are able to conform to slight differences in workpiece geometry. However, the guide holes being provided in flexible material means they offer less support to a drill bit passing therethrough, and precision of hole placement may be reduced. Also, the guide holes only extending through a sheet (and a flexible sheet at that) means that such templates are not generally able to guide the angle of the drill. It is therefore difficult to drill holes at the required angles, particularly where the holes are to be drilled non-perpendicularly to the surface of the workpiece.

Similar problems also exist in respect of machining operations using other rotary tools, such as countersinking, reaming, counterboring and tapping.

The present invention seeks to mitigate one or more of the above-mentioned problems. Alternatively or additionally, the present invention seeks to provide an improved or alternative rotary tool guide, orientation structure for a rotary tool, method of machining a workpiece, workpiece or aircraft.

### SUMMARY OF THE INVENTION

According to a first aspect of the present invention there is provided a rotary tool guide comprising:
an underside configured for abutment with a workpiece, and a top side facing away from the underside;
a plurality of rigid guide members; and
a plurality of guide holes each arranged to guide a rotary tool, wherein:
   each guide hole extends along a longitudinal axis and passes through the top side, through a guide member and through the underside; and
   the guide members are distributed in an elongate array with flexible portions therebetween, the flexible portions allowing the elongate array to bend so as to change the shape of the underside.

With the underside being able to change shape, the rotary tool guide may be able to adapt to different workpiece geometries. The rotary tool guide may therefore be able to offer the necessary degree of precision in the face of variations in workpiece geometry due to manufacturing tolerances and the like. Instead or as well, the rotary tool guide may be able to be used for workpieces of intentionally different geometry (for instance man-holes in different locations in a wing, where the curvature of the wing may differ).

Furthermore, with the guide holes extending through the guide members, which are rigid, sufficient support may be offered to the rotary tool passing therethrough. The rotary tool guide may therefore offer improved precision in hole placement and angle, and may enable non-perpendicular holes to be drilled.

For the avoidance of doubt, reference herein to “drilling” is intended to be illustrative in nature. It is to be understood that the rotary tool guide may be configured to support any suitable rotary tool for any suitable machining operation, for instance a drill bit or milling cutter for drilling or counterboring, a countersink for countersinking, a tap for threading and/or a reamer for reaming.

Where further clarification is needed despite the understanding of the skilled person, a rotary tool may interpreted to be any tool which is arranged to cut a workpiece while the tool rotates about a longitudinal axis thereof.

It is to be understood that reference herein to flexible portions should be interpreted in the context of precision tooling. Accordingly, is not intended to imply that a flexible portion must necessarily flex under its own weight or flex in the hands of a user without mechanical advantage. In some embodiments flexible portions may appear rigid to a user until the rotary tool guide is in use.

For the avoidance of doubt, a guide member may be considered to be rigid if it does not deform to any appreciable extent during normal use. In some embodiments the guide members may be capable of withstanding, without appreciable deformation, flexural loading which is sufficient to damage the flexible portions.

The elongate array may be generally annular.

An annular array generally extends over a greater workpiece area than a straight or arcuate array. Accordingly, the potential problems caused by variation in workpiece surface shape may be particularly prevalent. One or more of the advantages discussed above may therefore be particularly impactful under such circumstances.

Where the elongate array is generally annular it may be generally circular, elliptical or oval, for example. As an alternative to being annular, the elongate array may follow a substantially straight or a curved line, for example.

The elongate array may extend along a length direction, and have a width direction and a depth direction, the flexible portions allowing the elongate array to bend in at least the depth direction.

In other words, the array may configured to bend forwards/backwards rather than necessarily side to side. Accordingly, the rotary tool guide may be configured to conform to convex/concave workpiece surfaces. This may be particularly beneficial for use in the manufacture of aircraft, where workpiece surfaces are more likely to have variations in convexity/concavity.

The width direction may be generally parallel to the underside and/or the top side of the rotary tool guide. Instead or as well, the width direction may be substantially perpendicular to the longitudinal axes of the guide holes.

The depth direction may be generally normal to underside and/or top side of the rotary tool guide. Instead or as well, the depth direction may be generally parallel to the longitudinal axes of the guide holes.

It is to be understood that where elongate array is annular or arcuate, the length direction may be the circumferential direction and the width direction may be the radial direction. Thus, it is clear that the length direction may follow a curved path and/or width direction may can change (in absolute terms) along the length direction. In other cases, however, the length direction and/or the width direction may be a straight line.

As an alternative, the flexible portions may allow the array to bend only in the width direction, for instance to adapt to variations in the desired locations of holes on the workpiece surface (e.g. aircraft manholes with slight variations in their elliptical shape).

Where the flexible portions allow the elongate array to bend in at least the depth direction, the flexible portions may allow the elongate array to bend substantially only in the depth direction.

Being substantially inflexible in the width direction may improve the precision which the rotary tool guide can position the guide holes in the required locations. In contrast, in an arrangement where the array could also bend in the depth direction then the rotary tool guide may inadvertently bend out of the shape required to correctly position the guide holes (for instance changing its aspect ratio slightly in the case of an elliptical or oval array).

Optionally:
the rotary tool guide further comprises a set of one or more tool support inserts; and
each tool support insert has a barrel which is snugly receivable in a guide hole, and a tool bore configured to guidingly receive a rotary tool therethrough.

The use of tool support inserts can allow the part(s) of the rotary tool guide which receive the rotary tool to be separable. This can allow tool support inserts to be replaced if they wear out or are damaged, rather than requiring the whole rotary tool guide to be replaced. Instead or as well, the part of the rotary tool guide which receives the rotary tool can be optimised for that purpose without affecting other parts. For sake of example the tool support insert(s) can be made of a hard and wear-resistant material for the sake of longevity, with the flexible portions being made out of a more flexible material.

Each tool support insert may have a head which projects beyond the top side when the outer surface is received within a guide hole. The head may be configured to engage the top side of the rotary tool guide.

The barrel of the or each tool support insert may be substantially circular in cross-section, for instance being cylindrical or frustoconical. Alternatively the barrel may have any other suitable shape, for instance being star-shaped, square, hexagonal or octagonal in cross section.

The tool support inserts may be substantially the same as one another. Alternatively, they may differ from one another in shape and/or material composition.

The barrel of the or each tool support insert may have a complementary cross-sectional shape to that of the guide hole in which it is snugly receivable (for example each barrel and each guide hole may be circular in cross section). This may improve the contact between the barrel and guide hole, allowing the guide hole to provide more support to the barrel.

At least one of the barrel of a tool support insert and the guide hole into which that barrel is snugly receivable may be circular in cross section. For example a tool support insert may have a cylindrical barrel snugly receivable in a guide hole which is square in cross section, or the tool support insert may have an octagonal cross section which is snugly receivable in a cylindrical guide hole, or both the barrel and the guide hole may be frustoconical or cylindrical. This may allow the barrel to be rotatable within the guide hole, which may be beneficial in some circumstances as discussed later.

As an alternative, both the barrel and the guide hole may be non-circular in cross section. This may prevent the barrel (and thus the tool support insert) rotating, for instance limiting it to occupying one or more discrete angular positions about the longitudinal axis of the guide hole.

For the avoidance of doubt, a barrel may be considered to be snugly receivable in a guide hole if the barrel can be received in the guide hole in a manner which substantially prevents lateral or sideways movement of the barrel.

Where the rotary tool guide comprises two or more tool support inserts, the tool support inserts may be substantially the same as one another, or may differ from one another in shape and/or material composition.

As an alternative to the use of tool support inserts, the guide holes may be configured to guidingly receive the rotary tool directly.

In each tool support insert the tool bore may define a bore axis and the barrel may define a barrel axis, the bore axis and the barrel axis being positioned at an angle to one another. The angle between the bore axis and the barrel axis is preferably non-zero. The bore axis and the barrel axis may be non-parallel. The bore axis and the barrel axis may be non-coaxial.

This can allow the tool support insert (and thus the rotary tool guide as a whole) to guide movement of a rotary tool in a direction which is at an angle to the longitudinal axis of the guide hole in which it is received.

The bore axis and the barrel axis may be positioned at an angle of at least 1 degree, for instance at least 2 degrees or at least 5 degrees to one another. Instead or as well, the bore axis and the barrel axis may be positioned at an angle of less than 20 degrees, for instance less than 15 degrees or less than 10 degrees to one another.

As an alternative, the bore axis and barrel axis may be collinear, whereupon the longitudinal axis of the guide hole determines the direction in which the rotary tool will be guided. As another alternative the bore axis and barrel axis may be parallel, for instance with the tool support insert resembling an eccentric bush. This may allow the path along which the rotary tool will be guided to be adjusted by changing the angular position of the tool support insert about the longitudinal axis of the guide hole.

Optionally:
the rotary tool guide comprises a set of one or more supplemental tool support inserts;
each supplemental tool support insert has a barrel which is snugly receivable in a guide hole, and a tool bore configured to guidingly receive a rotary tool therethrough; and
the supplemental tool support inserts differ in shape from the tool support inserts.

The rotary tool guide having both a tool support insert and a supplemental tool support insert can allow different operations to be performed (for instance drilling different diameter holes or holes at different positions or angles) depending on whether a tool support insert or a supplemental tool support insert is used. For sake of an example, the tool support insert(s) may have a tool bore of different diameter to the supplemental tool support insert(s), and/or the tool support insert(s) may have a tool bore at a different angle to the supplemental tool support insert(s).

One or more of the guide holes may be configured to snugly receive either a tool support insert or a supplemental tool support insert, as required. This can allow the same guide hole to guide different operations, accordingly.

Where the rotary tool guide comprises two or more supplemental tool support inserts, the supplemental tool support inserts may be substantially the same as one another, or may differ from one another in shape and/or material composition.

The rotary tool guide may further comprise a set of one or more clamp inserts configured to clamp the rotary tool guide against a workpiece, each clamp insert having a barrel which is snugly receivable in a guide hole, and a head configured to engage the top side.

With the clamp inserts having barrels that are snugly receivable in guide holes, the positions of the clamp inserts can be used to precisely locate the rotary tool guide on the workpiece.

As an alternative, the rotary tool guide may have clamp inserts which are configured to extend through or into respective guide holes without being snugly received. As another alternative, the rotary tool guide may comprise clamp members which are not receivable in guide holes. Such clamp members may, for example, abut the top side of the rotary tool guide.

One or more of the guide holes may be configured to snugly receive either a clamp insert or a tool support insert and/or supplemental tool support insert, as required. This can allow the same guide hole to be used either in clamping the rotary tool guide or in machining operation, as required.

Each clamp insert may have a shank which extends from the barrel in a direction generally away from the head, the shank being narrower than the barrel.

Such a shank may allow the clamp insert to extend into the workpiece without requiring a hole in the workpiece which is at least as large in diameter as the barrel.

The shank may be threaded, for instance threaded for engagement with a threaded hole supported in or on the workpiece.

The rotary tool guide may further comprise a set of one or more alignment projections, each alignment projection having an active configuration in which it extends from a guide member and projects beyond the top side.

The or each alignment projection can be arranged as a datum point for determining an angular position of a tool support insert and/or supplementary tool support insert. For example, a tool support insert may have a surface which is spaced apart from an alignment projection by a specific amount when the tool support insert is in a required angular position.

Instead or as well, the or each alignment projection may be configured to provide a stop side against which a surface of a tool support insert and/or supplemental tool support insert can rest when in a required angular position.

This functionality may be particularly beneficial when a tool support insert and/or a supplemental tool support insert has a bore axis that is not collinear with the barrel axis (whereupon the position of the bore axis relative to the longitudinal axis of the associated guide bore depends on the angular position of the tool support insert and/or supplemental tool support insert).

In the active configuration the alignment projection may extend from the guide member the guide hole of which receives the tool support insert. As an alternative, in the active configuration the alignment projection may extend from a guide member adjacent to that guide member.

Each alignment projection may also have a passive configuration in which it does not extend from a guide member.

This can allow the alignment projection(s) to be moved out of the way when not required.

Each alignment projection may have a passive configuration in which it is detached from the associated guide member. For example, each alignment projection may take the form of a screw which is engageable with a threaded hole in a guide block, the alignment projection being in the active configuration when screwed into the threaded hole and in the passive configuration when unscrewed from the hole.

Instead or as well, each alignment projection may have a passive configuration in which it is flush with or recessed beneath the associated guide member. For example, each alignment projection may take the form of a set screw which is engageable with a threaded hole in a guide block, the alignment projection being in the active configuration when partially unscrewed from the threaded hole and in the passive configuration when screwed fully into the threaded hole.

As an alternative to each alignment projection having a passive configuration, each alignment projection may be permanently attached to the associated guide member in the active configuration.

The longitudinal axes of the guide holes may each intersect the underside at an acute angle.

Accordingly, the rotary tool guide may be used to drill holes (or the like) which are not perpendicular to the workpiece surface, which is particularly difficult using conventional techniques.

The acute angle may be at least 1 degree, for instance at least 2 degrees or at least 5 degrees. Instead or as well, the acute angle may be no more than 20 degrees, for instance no more than 15 degrees or no more than 5 degrees.

As an alternative, the guide holes may each intersect the underside at a right angle.

The longitudinal axes of the guide holes may each intersect the top side at substantially 90 degrees.

This may provide particularly solid and stable contact between a head of a tool support insert, supplemental tool support insert or clamp insert.

The guide members and flexible portions may be integrally formed with one another, the flexible portions taking the form of narrowed sections of material.

This may allow the rotary tool guide to beneficially stronger, easier to manufacture and/or less prone to components becoming loose or detaching from one another over time.

The guide members and flexible portions may be integrally formed from aluminium, or any other suitable material such as another metal, a composite material such as carbon fibre, or a polymer such as nylon or aramid.

The flexible portions and the guide members may comprise different materials.

This can allow the materials from which the guide members and flexible portions are made to be more tailored to their specific requirements. For example, the flexible portions may be made from a material which is more flexible than the material from which the guide members are made.

The flexible portions may be formed from a continuous length of flexible material which provides the underside, the guide members being spaced along the continuous length of flexible material.

The flexible portions may comprise, or be formed from, spring steel. Instead or as well, the guide members may comprise, or be formed from, aluminium.

According to a second aspect of the present invention there is provided an orientation structure for orienting a rotary tool, the orientation structure having:
a base for engaging a workpiece, and a top side on an opposite face of the orientation structure to the base;
two or more inflexible orientation pieces;
two or more orientation apertures each positioned to receive a rotary tool therethrough, wherein:
each orientation aperture runs along a centre line and extends through the orientation structure, passing through the top side, one of the orientation pieces and the base;
the orientation pieces are positioned in a lengthwise arrangement, and are spaced apart from one another by pliable regions; and
the lengthwise arrangement, and thus the base, is bendable by deformation of the pliable regions.

Such an orientation structure may provide one or more of the advantages discussed above.

According to a third aspect of the present invention there is provided a method of machining a workpiece using a rotary tool guide of the first aspect of the invention, the method comprising:
placing the underside of the rotary tool guide in abutment with a workpiece surface;
securing the underside of the rotary tool guide in intimate contact with the workpiece surface by deforming one or more of the flexible portions so as to conform the shape of the underside to the shape of the workpiece surface; and
inserting a rotary tool through a guide hole of one of the guide members and into the workpiece to machine it, said guide hole guiding the movement of the rotary tool into the workpiece.

Due to its use of a rotary tool guide according to the first aspect of the invention, the method may allow machining operations to be performed with increased precision for the reasons discussed above. Instead or as well, it may allow the method to be performed on workpieces which differ from another with little or no modification of tooling or procedure.

Placement of the underside in abutment with the workpiece surface, and securing the underside in intimate contact with the workpiece surface, may take place at different stages of the same operation. For instance, the rotary tool guide may be aligned with the workpiece surface and then be clamped into place, tightening of the clamp mechanisms firstly bringing the underside into abutment with the workpiece surface before continued tightening secures the underside in intimate contact.

A rotary tool (either the same rotary tool or two or more different rotary tools) may be inserted through more than one (for instance all or substantially all) of the guide holes. Optionally:
the method further comprises inserting the barrel of a tool support insert into said guide hole before inserting the rotary tool; and
the guide hole guides the movement of the rotary tool via said tool support insert, the guide hole determining the position of the tool support insert and the tool bore of the tool support insert guiding the movement of the rotary tool into the workpiece.

The tool support insert may be inserted before, during or after placing the underside in abutment with the workpiece surface. Where the tool support insert is inserted after placing the underside in abutment with the workpiece surface, it may be inserted before, during or after securing the underside in intimate contact with the workpiece surface.

The tool support insert may be inserted into the guide hole until a head of the tool support insert contacts the top side of the rotary tool guide.

Optionally the method further comprises:
inserting the barrel of a supplemental tool support insert into a guide hole of one of the guide members; and subsequently
inserting a rotary tool through said guide hole and into the workpiece to machine it,
wherein the guide hole guides the movement of the rotary tool via the supplemental tool support insert, the guide hole determining the position of the supplemental tool support insert and the tool bore of the supplemental tool support insert guiding the movement of the rotary tool into the workpiece.

The supplemental tool support insert may be inserted before, during or after insertion of the tool support insert.

The rotary tool guided by the tool support insert may be the same as the rotary tool guided by the supplemental tool support insert (i.e. the tool support insert and supplemental tool support insert may support substantially identical rotary tools, or may support the same exact tool but at different points in time).

As an alternative, the tool support insert and the supplemental tool support insert may guide different tools. For example, the tool support insert may guide a drill bit performing a drilling operation and the supplementary tool support insert may guide a countersink performing a countersinking operation, for example.

The supplemental tool support insert may guide the associated rotary tool before, during or after the tool support insert guides the associated rotary tool.

The same guide hole may guide the movement of the rotary tool via the tool support insert and, at a different time, guide the movement of the rotary tool via the supplemental tool support insert.

In other words, the same guide hole(s) may be used to guide a cutting tool twice-once via the tool support insert and once via the supplemental tool support insert. Thus, two machining operations can be performed in the same place.

As an alternative, one guide hole may receive the tool support insert and another guide hole (such as an adjacent guide hole, for instance a guide hole of an adjacent guide member) may receive the supplemental tool support insert.

The step of inserting the barrel of a tool support insert into the guide hole may include securing the tool support insert in a required angular position about the longitudinal axis of the guide hole using an alignment projection that is in the active configuration.

The tool support insert may be inserted into the guide hole, rotated to the required angular position and then secured by the alignment projection. Alternatively, the tool support insert may be positioned in the correct angular position before being inserted into the guide hole (whereupon it may be secured by the alignment projection during or after insertion).

The step of securing the tool support insert in the required angular position may comprise rotating the tool support insert in the guide hole to the required angular position with the alignment projection in the passive configuration, then moving the alignment projection to the active configuration to secure the tool support insert.

The alignment projection may be moved to the active configuration before, during or after the tool support insert is inserted into the guide bore and/or before, during or after the tool support insert is positioned in the required angular position.

The method may further comprise repeating some or all of the above steps at a different location on a workpiece.

The step of securing the underside of the rotary tool guide in intimate contact with the workpiece surface may include:
inserting the barrels of two or more clamp inserts into respective guide holes;
engaging each clamp insert with a complementary structure supported by the workpiece so as to form a clamp mechanism; and
tightening the clamp inserts and their complementary structures to tighten the clamp mechanisms, thereby clamping the underside of the rotary tool guide against the workpiece surface and deforming said one or more of the flexible portions.

The complementary structures may be, for example, a threaded hole in the workpiece or in a nut supported in or on the workpiece.

The complementary structures may engage respective shanks of the clamp inserts.

As an alternative, complementary structures might take the form of bolts which are engageable with threaded openings in clamp inserts.

According to a fourth aspect of the present invention there is provided a workpiece machined using an apparatus of the first or second aspects of the invention and/or a method according to the third aspect of the invention.

The workpiece may be machined with advantageous precision as discussed above.

The workpiece may include a wing skin with a manhole provided therein. The manhole may have a circumferential array of holes machined using an apparatus according to the first aspect of the invention or a method according to the third aspect of the invention.

According to a fifth aspect of the invention there is provided an aircraft comprising a workpiece according to the fourth aspect of the invention.

The aircraft as a whole may be produced with advantageous precision due to improved precision of the machining of the workpiece. Instead or as well, the aircraft may be produced more quickly (and thus at lower cost) and/or with reduced tooling cost due to the same rotary tool guide being able to be used in two or more locations in place of separate jigs.

It will of course be appreciated that features described in relation to one aspect of the present invention may be incorporated into other aspects of the present invention. For example, a method according to the invention may incorporate any of the features described with reference to apparatus of the invention and vice versa. Similarly, the apparatus of the invention may include features configured to perform one or more steps or operations described in relation to a method of the invention. Further, it is to be noted that methods described herein are not intended to be limited to the steps of those methods being performed in the order in which they are recited. It would be readily apparent to the skilled person where steps can, or cannot, be performed in a different order.

### DESCRIPTION OF THE DRAWINGS

Embodiments of the present invention will now be described by way of example only with reference to the accompanying schematic drawings of which:

FIG. 1 shows a perspective view of an aircraft according to a first embodiment of the invention;

FIG. 2 is a perspective view of a manhole of the aircraft of FIG. 1;

FIG. 3 shows a plan view of a main body of a rotary tool guide according to the first embodiment;

FIG. 4 shows a side view of the main body of FIG. 2, aligned with a workpiece;

FIG. 5 shows cross-sectional view of the main body of FIGS. 3 and 4;

FIG. 6 shows a perspective view of a clamp insert of the rotary tool guide of the first embodiment;

FIG. 7 shows a perspective view of an alignment projection of the rotary tool guide of the first embodiment;

FIG. 8 shows a perspective view of the main body of FIGS. 2 to 4, in combination with clamp inserts as shown in FIG. 6 and alignment projections as shown in FIG. 7;

FIG. 9 shows a perspective view of a tool support insert of the rotary tool guide of the present embodiment;

FIG. 10 shows a top perspective view of a supplemental tool support insert of a second embodiment of the invention, located in a guide hole;

FIG. 11 shows a cross section of the supplemental tool support insert of FIG. 10, located in the guide hole;

FIG. 12 shows a perspective view of the main body of the second embodiment, in combination with the supplemental tool support insert of FIGS. 10 and 11, a tool support insert, a set of clamp inserts and a set of alignment projections

FIG. 13 shows a flow chart of a method according to the second embodiment of the invention.

### DETAILED DESCRIPTION

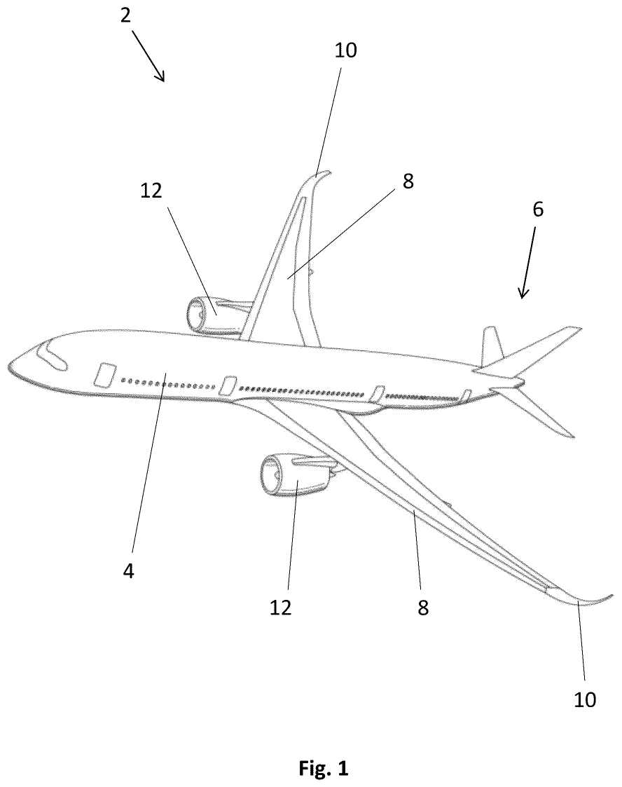

FIG. 1 shows an aircraft 2 according to an embodiment of the invention. It has a body 4, a tail 6 and two wings 8. Each wing 8 extends from the body 4 in a spanwise direction, terminates in an upturned wing tip 10, and supports an engine 12. Each wing has a set of manholes (not visible) on its underside, distributed along the span of the wing 8.

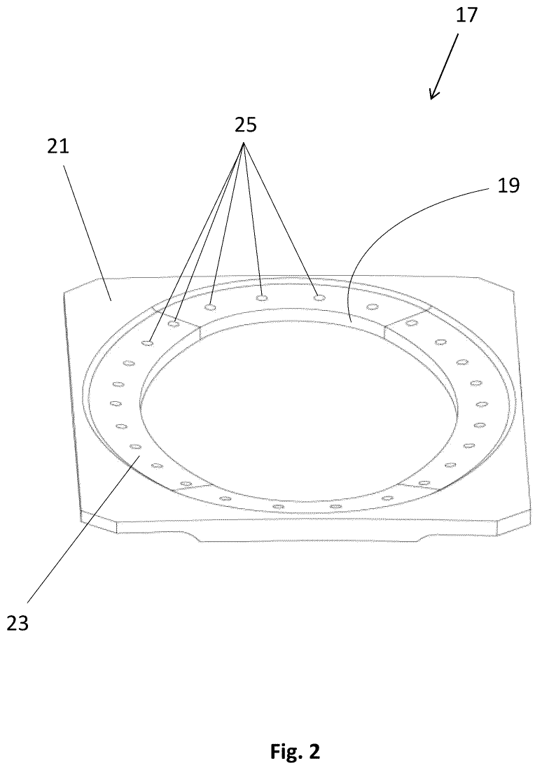

FIG. 2 shows one such manhole 19 before assembly of the wing 8, surrounded by a section of workpiece 17 which will form part of a lower skin of a wing 8 when assembled. The outer surface 21 of the workpiece 17 has a bevel 23 which runs circumferentially around the manhole 19 and is positioned at 7 degrees to parallel (i.e. a taper angle of 83 degrees). The bevel 23 also has an elliptical array of holes 25. Each hole 25 supports a captive nut for engagement by a bolt (not shown) extending through a manhole cover (not shown) to secure the cover over the manhole 19.

For the bolts (not visible) to fit correctly in the holes 25, the holes 25 must be provided at the correct locations and positioned at the correct angles. To ensure that they are located and positioned correctly, the holes 25 are machined using a rotary tool in the form of a drill, and a rotary tool guide according to the present embodiment.

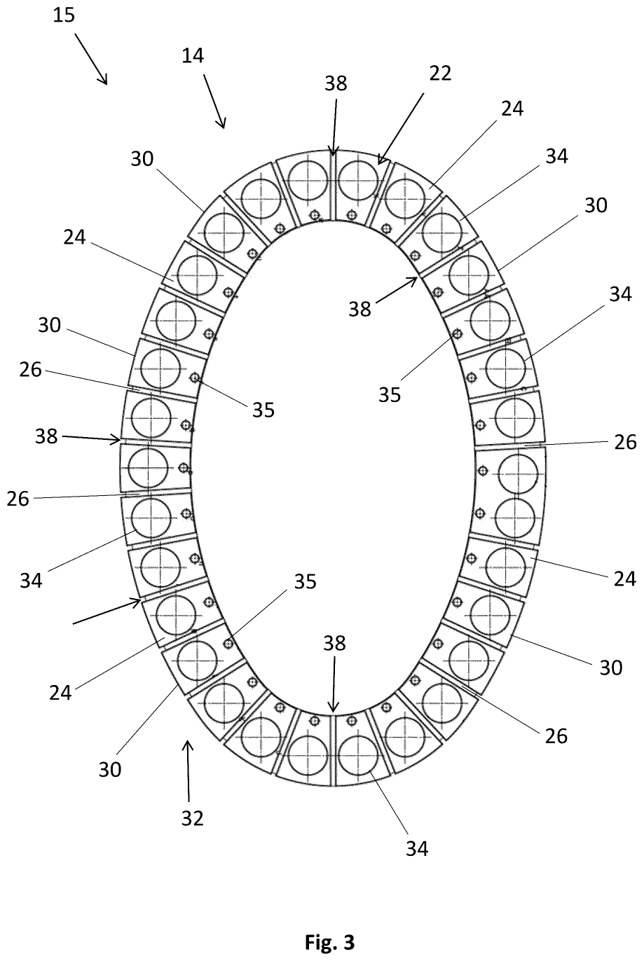

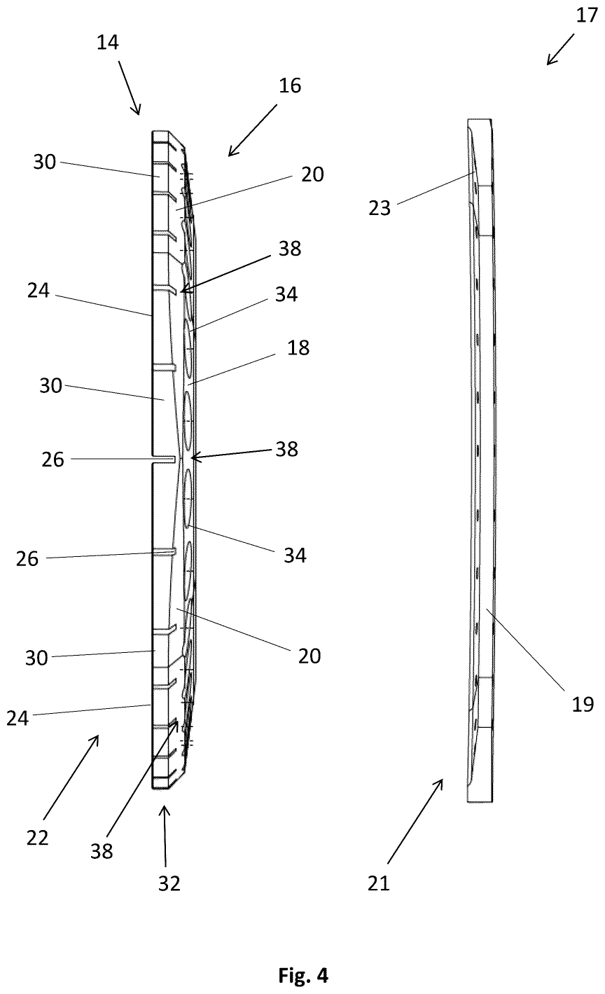

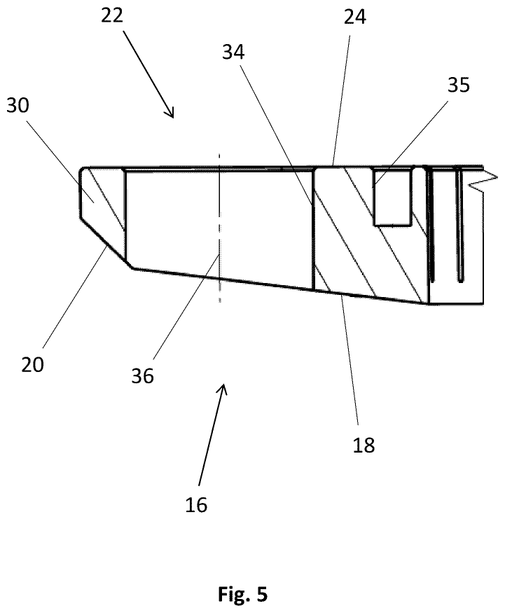

FIGS. 3, 4 and 5 show a main body 14 of the rotary tool guide 15 from the top, from the side and in cross-section respectively. FIG. 4 shows the main body 14 in alignment with the manhole 19 of the workpiece 17, with structural support members (not visible) beneath.

Referring now to FIGS. 3 to 5 in combination with FIGS. 1 and 2, the main body 14 of the rotary tool guide 15 has an underside 16 configured for abutment with the outer surface 21 of the workpiece (more specifically the bevel 23). The underside 16 of the main body 14 is made up of an abutment surface 18 and a pair of chamfer surfaces 20 of varying width. In use, the abutment surface 18 is pressed against a corresponding surface of the skin of the wing 8, more particularly the bevel 23, as discussed in more detail later. The abutment surface 18 therefore also has a taper angle of 83 degrees.

The main body 14 also has a top side 22 which faces away from the underside 16. In this embodiment the top side 22 has a saw-toothed shape, having raised portions 24 and lowered portions 26.

In this embodiment the main body 14 is a single piece of aluminium. The volume of aluminium beneath each of the raised portions 24 forms a rigid guide member 30. The rigid guide members 30 are distributed in an elongate array 32 which extends in a length direction. In this embodiment the length direction is the circumferential direction (into and out of the page from the perspective of FIG. 4). The array 32 is therefore not only elongate but annular, more specifically elliptical, in shape.

The array 32 also has a width direction which is the radial direction (left and right from the perspective of FIG. 4), and a depth direction which is the direction extending between the underside 16 and the top side 22 (up and down from the perspective of FIG. 4). The length direction, width direction and depth direction are all normal to one another. In the present embodiment the width of the array is the same as the width of the guide members 30, but in other embodiments two or more guide members may be positioned side-by-side in the array.

The main body 14 has a set of guide holes 34, each of which is arranged to guide a rotary tool such as a drill as discussed in more detail later. Each guide hole 34 extends along a longitudinal axis 36 and passes through the top side 22 (more particularly through one of the raised portions 24), through one of the guide members 30 and through the underside 16 (more particularly the abutment surface 18). Most of the guide members 30 have a single guide hole 34, but one of the guide members 30 (the guide member on the very right from the perspective of FIG. 3) has two guide holes 34. Each guide hole 34 is accompanied by an adjacent threaded blind bore 35, the purpose of which will be discussed later.

In the present embodiment the longitudinal axes 36 of the guide holes 34 each intersect the top side 22 at 90 degrees. Due to the abutment surface 18 having a taper, the longitudinal axes 36 of the guide holes intersect the abutment surface 18 (and thus the underside 16 as a whole) at an acute angle. With the taper angle of the abutment surface 18 being 83 degrees, the longitudinal axes intersect the abutment surface 18 at 83 degrees.

Whereas the guide members 30 have sufficient volume of aluminium to be rigid during use, beneath each of the lowered portions 26 of the top side 22 the portions 38 of material have a low enough volume to be flexible. These flexible portions 38, positioned between adjacent guide members 30, are configured to allow the array 32 to bend so as to change the shape of the underside 16. More particularly, in the present embodiment the flexible portions are wide enough to substantially prevent bending in the width direction, but are shallow enough that the array 32 (and thus the main body 14 as a whole) can bend in the depth direction.

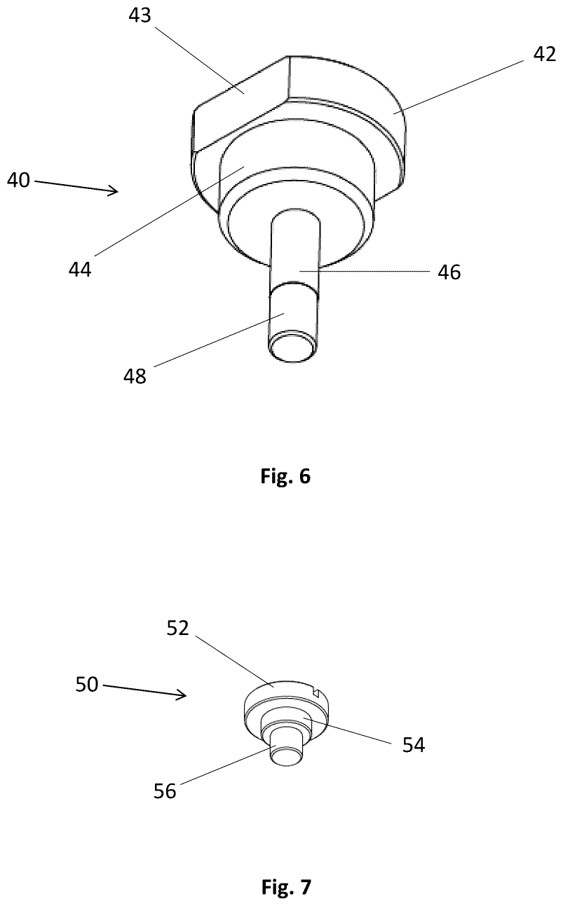

In order for the rotary tool guide 15 to guide the drill the holes 25 in the correct locations on the workpiece 17, the main body 14 must be secured to the workpiece in the correct position itself. The rotary tool guide 15 has a set of clamp inserts for this purpose, one of which is shown in FIG. 6. FIG. 6 will now be referred to in combination with FIGS. 1 to 5.

Each clamp insert 40 is configured to clamp the rotary tool guide 15 (in particular the main body 14) against the workpiece 17, and is substantially the same in structure and function. Each has a head 42, a cylindrical barrel 44, and a shank 46. The head 42 is configured to engage the top side 22 (more particularly a raised portion 24 thereof), and has a pair of flats 43. The barrel 44 is snugly receivable in a guide hole 34. In the present embodiment the guide holes 34 are substantially the same as one another, therefore the barrel 44 of any clamp insert 40 can be snugly received in any guide hole 34. The shank 46 is narrower than the barrel 44, extends from the barrel 44 in a direction away from the head 42, and has a threaded tip 48 for engagement with a threaded hole provided by a nut (not visible) supported by the workpiece 17 behind the skin.

By inserting the clamp inserts 40 into suitably-positioned guide holes 34, inserting their shanks 46 into respective nuts and tightening the clamp inserts 40 into the nuts, the main body 14 can be secured against the workpiece in the required position as described in more detail later.

The rotary tool guide 15 of this embodiment also has a set of alignment projections in the form of large-headed screws. FIG. 7 shows one of the alignment projections 50, and each of the alignment projections 50 are the same as that shown in FIG. 7. Each alignment projection 50 has a slotted head 52, a shoulder 54 and a threaded shank 56. The shanks 56 of the alignment projections 50 can be screwed into threaded blind bores 35 until the shoulder 54 abuts the top side 22, so as to place the alignment projections 50 into an active configuration. With an alignment projection 50 in the active configuration it extends from a guide member 30 (the guide member which has the blind bore 35 into which the alignment projection has been threaded) and projects beyond the top side 22. Equally, when not needed the alignment projections 50 can be unscrewed from their respective blind bores 35 to place them in a passive configuration in which they do not extend from a guide member 30.

The distance between each guide hole 34 and its associated blind bore 35 is selected such that with a clamp insert 40 in the guide hole 34, an alignment projection 50 can only be screwed into the blind bore 35 (i.e. moved to the active configuration) when one of the flats 43 of the head 42 of the clamp insert 40 faces directly towards the blind bore 35. By tightening the clamp insert 40 to a point at which one of the flats is so positioned, an alignment projection 50 can be screwed into the blind bore 35 so as to secure the clamp insert 40 in that angular position, preventing it from rotating and loosening, for instance due to vibration or an accidental knock.

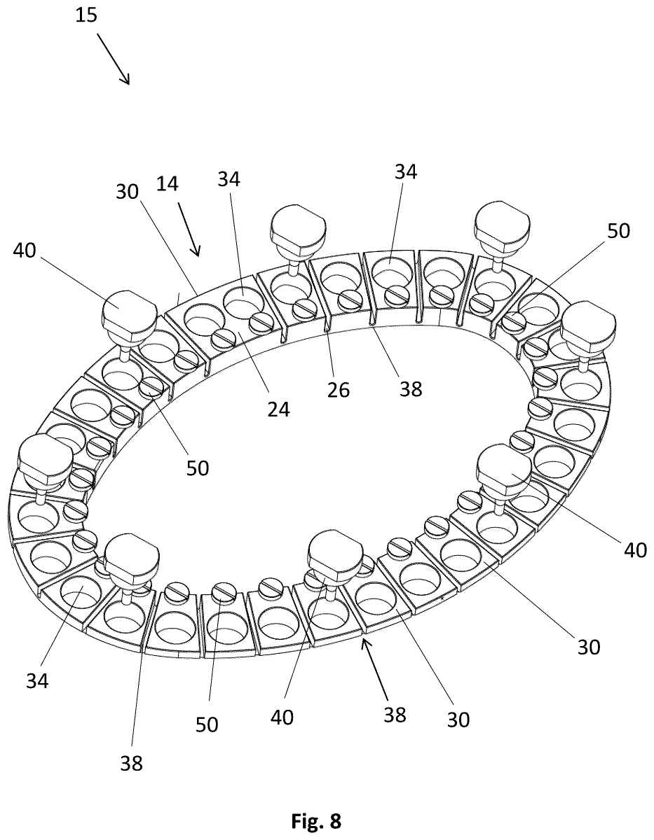

FIG. 8 shows the main body 14, all the clamp inserts 40 and all the alignment projections 50 together, positioned to engage the workpiece 17. The alignment projections 50 are all in respective active configurations. FIG. 8 will now be referred to in combination with FIGS. 1 to 7.

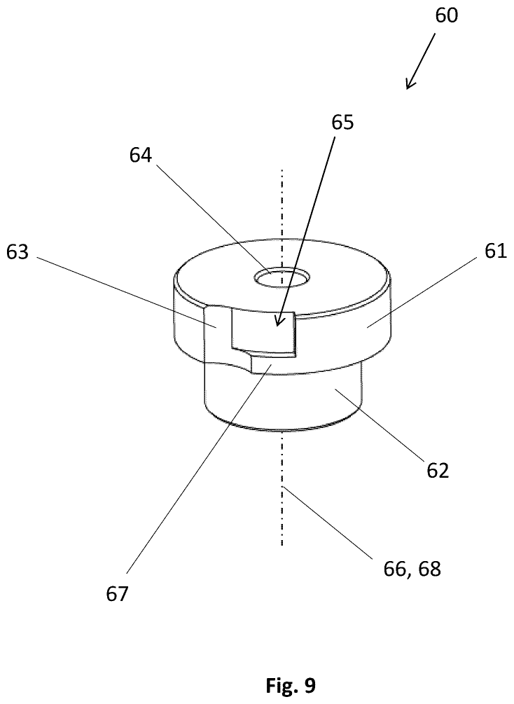

It is readily apparent from FIG. 8 that each blind bore 35 of the main body 14 has an associated alignment projection 50. Equally, it is apparent that there are many more guide holes 34 than clamp inserts 40. In the present use case those guide holes 34 which do not receive a clamp insert 40 instead receive a tool support insert. In this embodiment the tool support inserts are the same as one another. FIG. 9 shows one of the tool support inserts 60.

Referring now to FIG. 9 in combination with FIGS. 1 to 8, each tool support insert 60 has a head 61, a cylindrical barrel 62 and a tool bore 64. The barrel 62 is snugly receivable in a guide hole 34. The tool bore 64 is configured to guidingly receive the drill bit (not shown) of the drill, being sized to be a snug fit therewith so that the drill bit (not shown) must remain in line with the tool bore 64 during drilling.

The tool bore 64 defines a bore axis 66, along which the drill bit (not shown) is guided when passing therethrough. Equally, the barrel 62 defines a barrel axis 68. In this embodiment the bore axis 66, and the barrel axis 68 are collinear. Accordingly, with a tool support insert 60 received in a guide hole 34, the longitudinal axis 66 of the tool bore 64 will be at the same location, and at the same angle, regardless of the rotational position of the tool support insert 60 about the longitudinal axis 36 of the guide hole.

The head 61 is generally cylindrical but has a notch 63, and a recess 65 positioned above a lip 67. The notch 63 is shaped and positioned such that with the barrel 62 of the tool support insert 60 received in a guide hole 34 of the main body 14 and the notch 63 facing towards the corresponding threaded blind bore 35, the head 52 of an alignment projection 50 can move along the notch 63. This allows the tool support insert 60 to be placed into or taken out of a guide hole 34 with an alignment insert 50 remaining in the associated threaded hole 35, or equally allows an alignment insert to be screwed into or unscrewed from a threaded hole 35 with the tool support insert 60 remaining in the associated guide hole.

The lip 67 has a height slightly greater than that of the shoulder 54 of the alignment projection 50. Accordingly, it cannot fit under the head 52 of an alignment projection 50 when fully screwed into a threaded hole 35, but can do so if the alignment projection 50 is partly unscrewed. The alignment aperture 50 can therefore be used to secure the tool support insert 60 in a particular angular position (e.g. the position in which the notch 63 faces towards the threaded hole 35) by screwing it in fully, in the same manner as described above, but it can also be used to hold the head 61 of the tool support insert 60 against the top side 22 of the main body 14. In the present embodiment the latter functionality is of more utility, because the position of the tool bore 64 does not depend on the rotational position of the tool support insert 60 as noted above. By loosening the alignment projection 50 slightly, the space between the underside of the head 52 and the top side 22 of the main body 14 can be increased until it is larger than the height of the lip 67. The tool support insert 60 can then be rotated to insert the lip 67 beneath the head 52 of the alignment projection 50, with part of the head 52 of the alignment projection 50 being received within the recess 65 in the head 61 of the tool support insert 60. The alignment projection 50 can then be tightened down onto the lip 67 to secure the tool support insert 60.

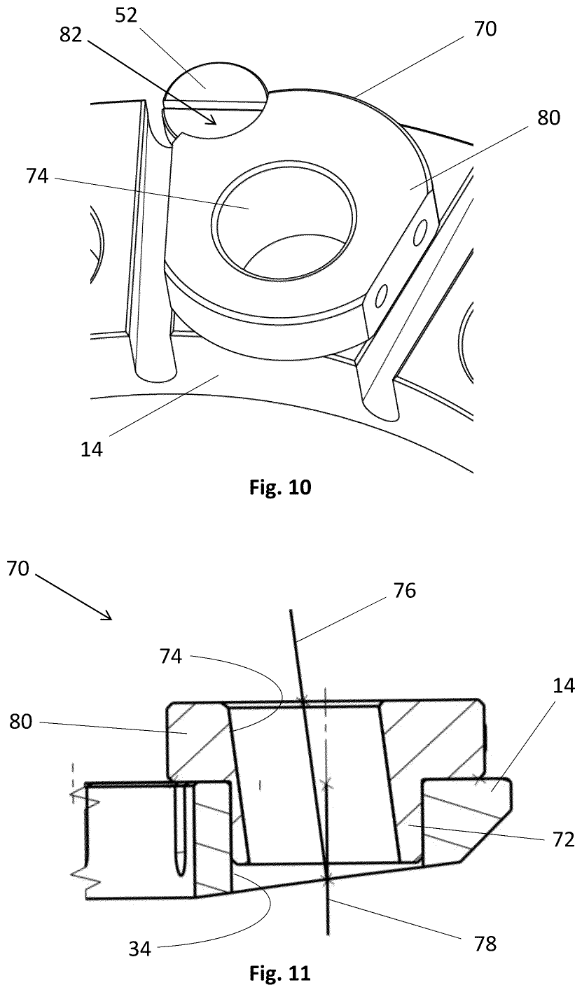

A rotary tool guide according to a second embodiment of the invention will now be described with reference to FIGS. 10 to 12, in combination with FIGS. 1 to 9. The rotary tool guide of the second embodiment is very similar to that of the first embodiment therefore only the differences will be described here, and reference numerals from FIGS. 1 to 9 will be used to denote corresponding features of this embodiment.

The main body 14 of this embodiment differs from that of the first embodiment only in the placement of the threaded blind bores 35 on the guide members 30. In the first embodiment they were positioned radially inward from their respective guide holes 34, whereas in the second embodiment they are positioned radially outward from their respective guide holes 34 and are offset in the length direction.

As well as tool support inserts 60, the rotary tool guide 15 of this embodiment has an equal number of supplemental tool support inserts 70. Like the tool support inserts 60, the supplemental tool guide inserts 70 each have a cylindrical barrel 72 which is snugly receivable in a guide hole 34, and a tool bore 74 configured to guidingly receive a rotary tool therethrough. Also, like the barrel 62 and tool bore 64 of the tool support inserts 60, the barrel 72 of each supplemental tool support insert 70 defines a barrel axis 78 and the tool bore 74 defines a bore axis 76.

While the supplemental tool support inserts 70 have many features in common with the tool support inserts 60, they differ in shape in a number of ways. Firstly, the heads 80 of the supplemental tool support inserts 70 are larger than the heads 61 of the tool support inserts 60 and lack their predominantly cylindrical shape. The head 80 of each supplemental tool support insert 70 does have a recess 82 which can accommodate a head 52 of a tool support portion, in a manner similar to the recess 65 of a tool support insert 60. However, the recess 82 is complementary shape to the head 52 of an alignment insert 50 whereas the recess 65 is not, and the head 80 lacks a notch like the notch 63 of the tool support insert 60.

The supplemental tool support inserts 70 also differ from the tool supports 60 in that the bore axis 76 and the barrel axis 78 are not collinear. Rather, they are positioned at an angle to one another. In the present case the bore axis 76 and barrel axis 78 are positioned at an angle of 7 degrees, making the tool bore 74 positionable to intersect the abutment surface 18 of the main body 14 at 90 degrees.

With the bore axis 76 and barrel axis 78 positioned at an angle to one another, the position and alignment of the bore axis 76 (and thus of a rotary tool guided thereby) depends upon the rotational position of the supplemental tool support insert 70 about the longitudinal axis 36 of the guide hole 34 in which it is received. The position of the recess 82 in the head 80 is selected such that with the recess 82 pointing to the blind bore 35 associated with the guide hole 34 in which the supplemental tool support insert 70 is received, the tool bore 74 is in the correct position.

In similar fashion to holding a clamp insert 40 or tool support insert 60 in the required rotational position, an alignment projection 50 can be placed in the active configuration so as to secure the supplemental tool support insert 70 in that position. When the alignment projection 50 is screwed into the blind bore 35, part of its head 42 is received in the recess 82, which prevents the supplemental tool support insert 70 from rotating out of position. Indeed, in the present embodiment the recess 82 is positioned above a lip (not visible) which is slightly taller than the shoulder 54 of the alignment projection 50. The recess 82 can therefore secure the supplementary tool support insert 70 in angular position in a similar manner to the notch 63 of the tool support insert 60, and also secure the supplementary tool support insert 70 against the top side 22 of the main body in a manner akin to the recess 65 of the tool support insert.

The supplemental tool support inserts 70 also differ in shape from the tool support inserts 60 in that their tool bores 74 are larger. This is because while the tool bores 64 of the tool support inserts 60 are sized to fit a drill bit, the tool bores 74 of the supplemental tool support inserts 70 are sized to fit a countersink.

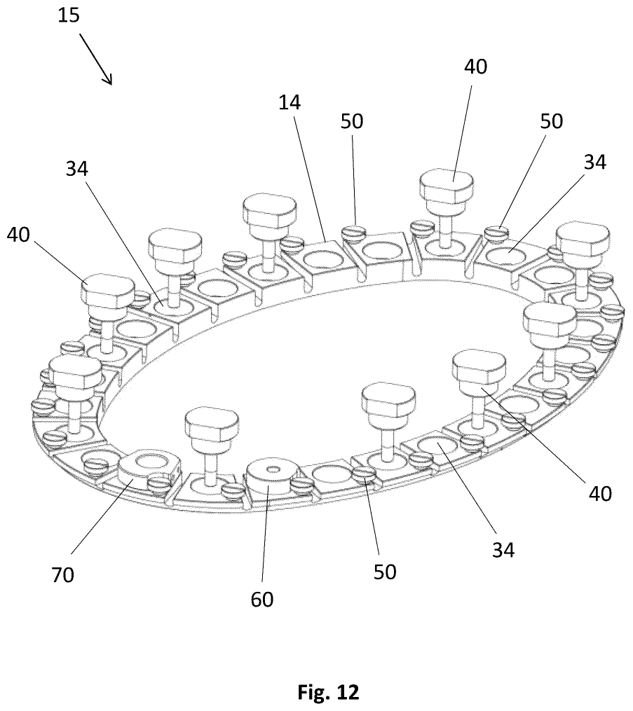

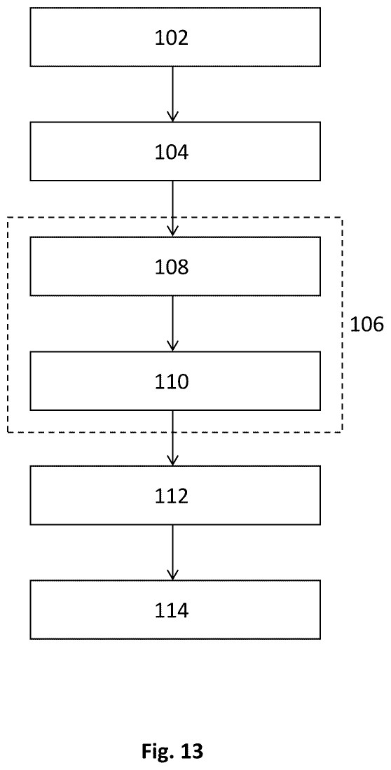

A method according to the second embodiment of the invention will now be described with reference to FIG. 12 in combination with FIGS. 1 to 11. The method of this embodiment is a method of machining a workpiece 17 to produce countersunk holes 25 around a set of manholes 19 in a wing 8 using the rotary tool guide 15.

In a first step 102 of the method, the main body 14 of the rotary tool guide 15 is introduced to the workpiece 17 with the alignment projections 50 in the passive configuration (i.e. not screwed into their respective threaded blind bores 35). The clamp inserts 40 are inserted into respective guide holes 34 with their barrels 44 snugly received therein, which inserts the tips 48 of their shanks 46 into respective complementary structures in the form of nuts (not visible) supported in the workpiece 17 behind the skin. The clamp inserts 40 are then rotated so as to threadedly engage the tips 48 of their shanks 46 with the nuts, forming a set of clamp mechanisms. The clamp mechanisms are tightened by continued rotation of the clamp inserts 40 until the underside 16 of the main body is in abutment with the outer surface 21 of the workpiece 17 (more specifically the abutment surface 18 of the underside 16 abuts the bevel 23 of the workpiece).

In step 104 the clamp mechanisms formed by the clamp inserts 40 and their respective nuts (not shown) continue to be tightened. This clamps the underside 16 against the workpiece 17 and secures it in intimate contact with the workpiece surface 21 (more particularly the bevel 23) and secures it in that position. Where necessary, some of the flexible portions 38 deform, bending so as to bend the array 32 of guide members 30 in the depth direction, allowing the underside 16 to conform to the shape of the outer surface 21 of the workpiece 17 and provide that intimate contact. Each clamp insert 40 is tightened until one of the flats 43 on its head 42 points towards the corresponding threaded blind bore 35, whereupon an alignment projection is inserted into that bore 35 to secure the clamp insert 40 in the required rotational position and prevent it from loosening unintentionally.

With the underside 16 of the main body 14 in intimate contact with the workpiece surface 21, the guide holes 34 are located in the required positions and at the required angles relative to the workpiece 17. In step 106 rotary tools (not shown) are inserted through some of the guide holes 34 (those that do not accommodate clamp insets 40) into the workpiece 17 to machine it, with said guide holes 34 guiding the movement of the rotary tools (not shown) into the workpiece 17.

In the present embodiment this step is performed as two stages 108, 110. In the first stage 108, which is a drilling stage, tool support inserts 60 are inserted into all the guide holes 34 that do not accommodate clamp inserts 40, and secured us more alignment inserts 50. Each alignment insert 50 is screwed into one of the threaded blind bores 35, with the head 52 of the alignment insert 50 progressively travelling along the notch 63 of the associated tool support insert 60, then the tool support insert 60 is rotated to place its lip 67 under the alignment insert 50 and the alignment insert 50 is tightened to hold the tool support insert 60 against the top side 22 of the main body 14.

A rotary tool in the form of a drill is then inserted into the tool bores 64 of each tool support insert 60 in turn, drilling the holes around the manhole 19. For each hole the relevant guide hole 34 guides the movement of the drill bit (not shown) indirectly via the tool support insert 60, with the guide hole 34 determining the position of the tool support insert 60 and the tool support insert physically guiding the movement of the drill bit using the tool bore 64. After all the holes have been drilled, the tool support inserts 60 are removed from their respective guide holes 34 in preparation for the second stage 110. In this embodiment the alignment projections 50 securing the tool support inserts 60 are removed completely, rather than merely being loosened to release the lips 67 of the tool support inserts 60.

The second stage 110 is a countersinking stage. Supplemental tool support inserts 70 are inserted into all the guide holes 34 that are not occupied by clamp inserts 40 (i.e. the same guide holes 34 that previously guided the movement of the drill (not shown) via the tool support inserts 60). Each supplemental tool support insert is then secured in the required rotational position using one of the alignment inserts 50 previously removed. After each supplemental tool support insert 70 is inserted into a guide hole 34, it is rotated about the longitudinal axis 36 of that guide hole 34 until the recess 82 in its head is aligned with the associated threaded blind bore 35. An alignment projection 50 is then screwed into that bore 35, its head 52 being received in the recess 82 to secure the supplemental tool support insert 70 in the required rotational position (and to secure its head 80 against the main body 14).

With the supplemental tool support inserts 70 secured, a second rotary tool in the form of a countersink (not shown) is inserted into the tool bores 74 of each supplemental tool support insert 70 in turn, through the guide holes 34 and into the workpiece 17 to countersink the holes that were drilled in the previous stage 108. For each hole the relevant guide hole 34 guides the movement of the countersink (not shown) indirectly via the supplemental tool support insert 70, with the guide hole 34 determining the position of the supplemental tool support insert 70 and the supplemental tool support insert 70 physically guiding the movement of the countersink using the tool bore 74.

In step 112, the rotary tool guide 15 is removed from the workpiece 17. The alignment projections 50 securing them are unscrewed to move them to the passive configuration, and the clamp inserts 40 are rotated to loosen the clamp mechanisms and disengage their threaded tips 48 from the nuts (not shown). The main body 14 and clamp members 40 can then be removed from the workpiece together with one another, or separately.

In a modification of the present embodiment clamp members 40 may then be inserted into different guide holes 34 to re-attach the main body and allow holes to be drilled under the guidance of the guide holes that previously contained clamp members 40. In this embodiment, however, sufficient holes are produced without this step.

In a final step 114 the remaining alignment projections 50 are removed, followed by the supplemental tool support inserts 70. The rotary tool guide 15 is then ready to be used for another manhole 19, either in a different location on the same workpiece 17 or on a different workpiece. In the present embodiment the above steps are performed three times to produce three different manholes on a wing 8, with the same rotary tool guide being used for each case.

It is to be understood that numerous modifications of the above described embodiments may also fall within the scope of the invention as defined by the appended claims. For example, in the above embodiments the guide members and flexible portions are integrally formed with one another from a single piece of aluminium. In one modification the guide members are each made from aluminium but the flexible portions are provided by a continuous annular spring steel strip to which the guide members are attached.

For the avoidance of doubt, it is to be understood that the terms “tool support insert” and “supplemental tool support insert” do not imply any specific order of use. In the above embodiments the tool support inserts may equally be considered to be supplemental tool support inserts, and the supplemental tool support inserts may considered to be tool support inserts.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments. The term ‘or’ shall be interpreted as ‘and/or’ unless the context requires otherwise.

1. A rotary tool guide comprising:
an underside configured for abutment with a workpiece, and a top side facing away from the underside;
a plurality of rigid guide members; and
a plurality of guide holes each arranged to guide a rotary tool, wherein:
each guide hole extends along a longitudinal axis and passes through the top side, through a guide member and through the underside; and
the guide members are distributed in a generally annular elongate array with flexible portions therebetween, the flexible portions allowing the generally annular elongate array to bend so as to change the shape of the underside, wherein:
the rotary tool guide further comprises a set of one or more tool support inserts; and
each tool support insert has a barrel which is snugly receivable in a guide hole, and a tool bore configured to guidingly receive a rotary tool therethrough, and
wherein in each tool support insert the tool bore defines a bore axis and the barrel defines a barrel axis, the bore axis and the barrel axis being positioned at an angle to one another.

2. The rotary tool guide according to claim 1, wherein the elongate array extends along a length direction, and has a width direction and a depth direction, the flexible portions allowing the elongate array to bend in at least the depth direction.

3. The rotary tool guide according to claim 2, wherein the flexible portions allow the elongate array to bend substantially only in the depth direction.

4. The rotary tool guide according to claim 1, wherein the rotary tool guide comprises a set of one or more supplemental tool support inserts;
each supplemental tool support insert has a barrel which is snugly receivable in a guide hole, and a tool bore configured to guidingly receive a rotary tool therethrough; and
the supplemental tool support inserts differ in shape from the tool support inserts.

5. The rotary tool guide according to claim 1, further comprising a set of one or more clamp inserts configured to clamp the rotary tool guide against a workpiece, each clamp insert having a barrel which is snugly receivable in a guide hole, and a head configured to engage the top surface.

6. The rotary tool guide according to claim 5, wherein each clamp insert has a shank which extends from the barrel in a direction generally away from the head, the shank being narrower than the barrel.

7. The rotary tool guide according to claim 1, further comprising a set of one or more alignment projections, each alignment projection having an active configuration in which it extends from a guide member and projects beyond the top surface.

8. The rotary tool guide according to claim 7, wherein each alignment projection also has a passive configuration in which it does not extend from a guide member.

9. The rotary tool guide according to claim 1, wherein the longitudinal axes of the guide holes each intersect the underside at an acute angle.

10. The rotary tool guide according to claim 1, wherein the longitudinal axes of the guide holes each intersect the top surface at substantially 90 degrees.

11. The rotary tool guide according to claim 1, wherein the guide members and flexible portions are integrally formed with one another, the flexible portions taking the form of narrowed sections of material, or wherein the flexible portions and the guide members comprise different materials.

12. An orientation structure for orienting a rotary tool, the orientation structure having:
a base for engaging a workpiece, and a top surface on an opposite face of the orientation structure to the base;
two or more inflexible orientation pieces;
two or more orientation apertures each positioned to receive a rotary tool therethrough, wherein:
each orientation aperture runs along a centre line and extends through the orientation structure, passing through the top surface, one of the orientation pieces and the base;
the orientation pieces are positioned in a lengthwise arrangement along an elliptical path to form an elliptical layout of orientation pieces, and are spaced apart from one another by pliable regions; and
the elliptical layout, and thus the base, is bendable by deformation of the pliable regions, and wherein:
the orientation structure further comprises a set of one or more tool support inserts; and
each tool support insert has a barrel which is snugly receivable in an orientation aperture, and a tool bore configured to guidingly receive a rotary tool therethrough, and
wherein in each tool support insert the tool bore defines a bore axis and the barrel defines a barrel axis, the bore axis and the barrel axis being non-parallel to one another.

13. A method of machining a manhole in a workpiece, using the rotary tool guide of claim 1, the method comprising:
placing the underside of the rotary tool guide in abutment with a workpiece surface;
securing the underside of the rotary tool guide in intimate contact with the workpiece surface by deforming one or more of the flexible portions so as to conform the shape of the underside to the shape of the workpiece surface; and
inserting a rotary tool through a guide hole of one of the guide members and into the workpiece to machine it, said guide hole guiding the movement of the rotary tool into the workpiece, wherein:
the method further comprises inserting the barrel of the tool support insert into said guide hole before inserting the rotary tool; and
the guide hole guides the movement of the rotary tool via said tool support insert, the guide hole determining the position of the tool support insert, and the tool bore of the tool support insert guiding the movement of the rotary tool into the workpiece, and
wherein the step of inserting the barrel of a tool support insert into the guide hole includes securing the tool support insert in a required angular position about the longitudinal axis of the guide hole.

14. The method according to claim 13, wherein the method further comprises:
inserting the barrel of a supplemental tool support insert into a guide hole of one of the guide members; and subsequently
inserting a rotary tool through said guide hole and into the workpiece to machine it, wherein the guide hole guides the movement of the rotary tool via the supplemental tool support insert, the guide hole determining the position of the supplemental tool support insert and the tool bore of the supplemental tool support insert guiding the movement of the rotary tool into the workpiece, wherein the same guide hole guides the movement of the rotary tool via the tool support insert and, at a different time, guides the movement of the rotary tool via the supplemental tool support insert.

15. A workpiece comprising a wing skin with a manhole provided therein, the perimeter of the manhole having a circumferential, elliptical, array of holes machined using the rotary tool guide of claim 1.

16. An aircraft comprising a workpiece according to claim 15.
